(19) United States
(12) Patent Application Publication
(10) Pub. No.: US 2019/0381979 A1
(43) Pub. Date: Dec. 19, 2019

(54) BRAKING CONTROL DEVICE FOR VEHICLE

(71) Applicant: ADVICS CO., LTD., Kariya-shi, Aichi-ken (JP)

(72) Inventor: Atsuto HIROTA, Obu-shi, Aichi-ken (JP)

(73) Assignee: ADVICS CO., LTD., Kariya-shi, Aichi-ken (JP)

(21) Appl. No.: 16/478,658

(22) PCT Filed: Feb. 23, 2018
(86) PCT No.: PCT/JP2018/006600

§ 371 Date: Jul. 17, 2019

(30) Foreign Application Priority Data
Feb. 24, 2017 (JP) 2017-033732

(51) Int. Cl. B60T 8/171; B60T 7/12; B60W 30/18

(52) U.S. Cl. CPC B60T 8/171; B60T 2201/06; B60W 30/18118; B60T 7/12

(57) ABSTRACT

A braking control device includes a determination unit that determines whether or not a shift range has changed when a transition is made from a stop-preceding moving state to a stopped state, and a braking control unit that, in a situation in which the determination unit has made an affirmative determination, carries out a braking force increasing process when a transition is made from a stopped state to a stop-following moving state. Even when a transition is made from a stopped state to a stop-following moving state in a situation in which the determination unit has made an affirmative determination, the braking control unit carries out a braking force increasing process or a limiting process on the condition that the moving direction of the vehicle in the stop-following moving state be the opposite direction of the moving direction of the vehicle in the stop-preceding moving state.

### TECHNICAL FIELD

The present invention relates to a braking control device for a vehicle configured to control a braking force for a vehicle.

### BACKGROUND ART

When a vehicle is stopped on a slope road as a result of applying a braking force to the vehicle, if the braking force is small, the vehicle cannot keep the stopped state, so that the vehicle may move downhill on the slope road. Therefore, in a braking control device disclosed in PTL 1, when a vehicle is stopped as a result of applying a braking force to the vehicle, a braking force increasing process of increasing the braking force for a vehicle is carried out, on condition that a shift range, which is a range of a shift device of the vehicle, has changed from a traveling range (for example, a drive range) to a non-traveling range (for example, a neutral range). The braking force increasing process is carried out in this way, so that it is possible to keep the stopped state of the vehicle.

Also, in a braking control device disclosed in PTL 2, it can be determined that the vehicle starts to move downhill when a number of pulses, which is acquired from a detection signal output from a wheel speed sensor in a situation where it is determined that the vehicle is stopped, becomes a prescribed number or larger. For this reason, in this case, the braking force increasing process is carried out to increase the braking force for a vehicle. By doing so, it is possible to suppress the vehicle from moving downhill on the slope road.

### CITATION LIST

### Patent Literature

PTL 1: JP-A-2014-227041

PTL 2: JP-A-2000-25589

### SUMMARY OF INVENTION

### Technical Problem

For example, after the vehicle traveling on the slope road is stopped, the shift range may be changed so as to move the vehicle in an opposite direction (a backward movement direction) to a traveling direction (for example, a forward movement direction) of the vehicle so far. For example, when a vehicle traveling on an uphill road is stopped, a driver of the vehicle may intend to move downhill the vehicle on the uphill road by changing the shift range from the drive range to the reverse range or the neutral range.

At this time, according to the device disclosed in PTL 1, when the shift range is changed from the traveling range to the non-traveling range during the stop of the vehicle, the braking force increasing process is carried out as a result of the change of the shift range. In this case, since the braking force for a vehicle increases as a result of the braking force increasing process, it is not possible to move the vehicle in the opposite direction.

Also, according to the device disclosed in PTL 2, even though the vehicle starts to move in the opposite direction after the change of the shift range during the stop of the vehicle, when the number of pulses, which is acquired from the detection signal from the wheel speed sensor, becomes the prescribed number or larger, the braking force increasing process is carried out. Also in this case, since the braking force for a vehicle increases as a result of the braking force increasing process, the movement of the vehicle in the opposite direction is restrained.

### Solution to Problem

In order to solve the above problems, a braking control device for a vehicle includes a determination unit and a braking control unit. The determination unit determines, when a transition is made from a stop-preceding moving state where a vehicle travels in one direction of a forward movement direction and a backward movement direction to a stopped state where the vehicle stops, whether a shift range has changed from a range for one direction to a range for other direction or to a neutral range. The range for one direction is a shift range for enabling the vehicle to travel in the one direction. The range for the other direction is a shift range for enabling the vehicle to travel in the other direction of the forward movement direction and the backward movement direction. In a situation where it is determined that the shift range has changed from the range for one direction to the range for other direction or the neutral range upon the transition from the stop-preceding moving state to the stopped state, the braking control unit carries out a braking force increasing process of increasing a braking force for a vehicle by an actuation of a braking device for a vehicle when a transition is made from the stopped state to a stop-following moving state where the vehicle moves. Even when the transition is made from the stopped state to the stop-following moving state in the situation that the determination unit has determined that the shift range has changed from the range for one direction to the range for other direction or the neutral range upon the transition from the stop-preceding moving state to the stopped state, the braking control unit does not carry out the braking force increasing process or carries out a limiting process of reducing an increase amount of the braking force in the braking force increasing process, on condition that a moving direction of the vehicle in the stop-following moving state is an opposite direction to a moving direction of the vehicle in the stop-preceding moving state.

According to the above configuration, when the vehicle traveling uphill (the one direction) on a slope road is stopped as a result of applying a braking force, if the shift range is changed from the range for one direction to the range for other direction or the neutral range, a drive force for enabling the vehicle to travel uphill (the one direction) is not applied to the vehicle. At this time, the vehicle may start to move downhill (the other direction). In this case, the braking force increasing process is not carried out, i.e., the braking force for a wheel is not increased or the limiting process of reducing the increase amount of the braking force in the braking force increasing process is carried out. For this reason, the downhill (the other direction) movement of the vehicle on the slope road is difficult to be restrained.

Therefore, according to the above configuration, the uphill side of the slope road is the one direction and the downhill side of the slope road is the other direction, it is possible to enable the vehicle, which is moving uphill on the slope road, to move downhill by the change of the shift range during the stop of the vehicle.

### BRIEF DESCRIPTION OF DRAWINGS

FIG. 1 is a schematic configuration view depicting a part of a vehicle having a braking control device for a vehicle in accordance with a first exemplary embodiment.

FIG. 2 is a map that is to be used when setting a stop-keeping braking force.

FIG. 3 is a flowchart depicting a process routine that is to be executed by the braking control device.

FIG. 4 is an operation view depicting an aspect where a vehicle is stopped on an uphill road.

FIG. 5 is an operation view depicting an aspect where the vehicle is moving downhill on the uphill road.

FIG. 6 is a flowchart depicting a part of a process routine that is to be executed by the braking control device in a second exemplary embodiment.

FIG. 7 is a flowchart depicting a part of a process routine that is to be executed by the braking control device in a third exemplary embodiment.

### DESCRIPTION OF EMBODIMENTS

### First Exemplary Embodiment

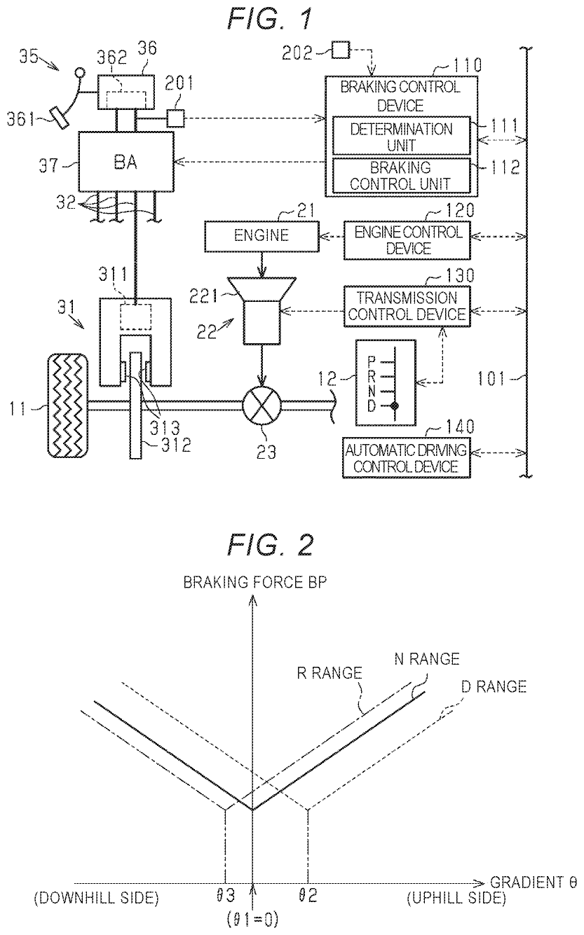

Hereinafter, a first exemplary embodiment of a braking control device for a vehicle is described with reference to FIGS. 1 to 5.

FIG. 1 pictorially depicts a part of a vehicle having a braking control device 110 in accordance with the first exemplary embodiment. As shown in FIG. 1, when drive torque output from an engine 21, which is an example of a drive source of the vehicle, is transmitted to a wheel 11 via a transmission device 22 and a differential gear 23, the wheel 11 is rotated, so that the vehicle travels. The transmission device 22 has a torque converter 221. For this reason, when a traveling range is selected as a shift range, which is a range selected by a shift device 12, and the engine 21 is operating, creep torque is input to the wheel 11, i.e., a drive force is applied to the vehicle even though a driver of the vehicle does not perform an accelerator operation.

Meanwhile, in FIG. 1, “D range” is a drive range, and “R range” is a reverse range. Also, in FIG. 1, “N range” is a “neutral range”, and is a range for interrupting torque transmission from the engine 21 to the wheel 11. Also, in FIG. 1, “P range” is a “parking range”, and is a range for parking.

Also, the vehicle includes a braking mechanism 31 provided for each wheel 11, and a braking device 35 coupled to a wheel cylinder 311 of each braking mechanism 31 via a piping 32. The braking mechanism 31 includes a rotary member 312 configured to rotate integrally with the wheel 11 and a frictional material 313 configured to move in directions of coming close to and separating from the rotary member 312, in addition to the wheel cylinder 311. In the braking mechanism 31, a WC pressure Pwc, which is a hydraulic pressure in the wheel cylinder 311, is adjusted to adjust a force of pressing the frictional material 313 to the rotary member 312, i.e., a braking force to be applied to the wheel 11.

A hydraulic pressure generation device 36 of the braking device 35 is coupled with a braking operation member 361 such as a brake pedal. An MC pressure Pmc, which is a hydraulic pressure in a master cylinder 362 provided to the hydraulic pressure generation device 36, becomes higher as an operation amount of the braking operation member 361 increases, i.e., the braking force requested by the driver is higher. When the braking operation member 361 is operated, the hydraulic pressure generation device 36 supplies a brake fluid corresponding to the operation amount into the wheel cylinder 311 through a braking actuator 37. For this reason, the braking device 35 can increase the braking force for a vehicle as a braking force request value BPRq, which is a braking force requested by the driver and is associated with the operation amount of the braking operation member 361, increases.

The braking actuator 37 of the braking device 35 is configured to adjust a differential pressure between the master cylinder 362 and the wheel cylinder 311. That is, the braking actuator 37 can increase the WC pressure Pwc even when the braking operation member 361 is not operated.

Subsequently, a control system of the vehicle is described with reference to FIG. 1.

As shown in FIG. 1, the vehicle is provided with a plurality of control devices 120, 130, 140, in addition to the braking control device 110. The braking control device 110 is electrically connected with a hydraulic pressure sensor 201 configured to detect the MC pressure Pmc and a wheel speed sensor 202 configured to detect a wheel speed VW, which is a rotating speed of the wheel 11. The braking control device 110 is configured to control the braking actuator 37 of the braking device 35. The engine control device 120 is electrically connected with a variety of sensors required to control the engine 21, and the engine control device 120 is configured to control the engine 21. Also, the transmission control device 130 is electrically connected with the shift device 12, and the transmission control device 130 is configured to control the transmission device 22.

Also, the vehicle includes an automatic driving control device 140 in which an application for automatic driving and an application for vehicle speed automatic control such as adaptive cruise control are installed. The respective control devices 110, 120, 130, 140 are configured to transmit and receive a variety of information each other via a communication bus 101.

In the meantime, as shown in FIG. 1, the braking control device 110 includes a determination unit 111 and a braking control unit 112, as functional units for adjusting the braking force for a vehicle when the vehicle stops.

The determination unit 111 determines whether the shift range has changed when a transition is made from a stop-preceding moving state where the vehicle travels to a stopped state where the vehicle stops. Specifically, in a case where the vehicle moves forward, the determination unit 111 determines whether the shift range has changed from the D range to the R range or the N range when a transition is made from the stop-preceding moving state where the vehicle travels in a forward movement direction to the stopped state. Like this, in a case where the moving direction of the vehicle in the stop-preceding moving state is the forward movement direction, the forward movement direction corresponds to “one direction”, and the backward movement direction corresponds to “the other direction”. Also, the D range of the shift range corresponds to “the range for one direction”, and the R range corresponds to “the range for other direction”.

Also, in a case where the vehicle moves backward, the determination unit 111 determines whether the shift range has changed from the R range to the D range or the N range when a transition is made from a stop-preceding moving state where the vehicle moves in a backward movement direction to the stopped state. Like this, in a case where the moving direction of the vehicle in the stop-preceding moving state is the backward movement direction, the backward movement direction corresponds to “one direction”, and the forward movement direction corresponds to “the other direction”. Also, the R range of the shift range corresponds to “the range for one direction”, and the D range corresponds to “the range for other direction”.

In the case where the transition has been made from the stop-preceding moving state where the vehicle travels in the forward movement direction to the stopped state, when a transition is made from the stopped state to a stop-following moving state where the vehicle travels after the shift range has changed to the R range or the N range, the braking control unit 112 carries out a braking force increasing process of increasing the braking force for a vehicle by an actuation of the braking actuator 37. Also, in the case where the transition has been made from the stop-preceding moving state where the vehicle travels in the backward movement direction to the stopped state, when a transition is made from the stopped state to the stop-following moving state after the shift range has changed to the D range or the N range, the braking control unit 112 carries out the braking force increasing process.

Also, even when the transition is made from the stopped state to the stop-following moving state after the shift range has changed, the braking control unit 112 does not carry out the braking force increasing process, i.e., does not increase the braking force for a vehicle if a condition to be described later is satisfied.

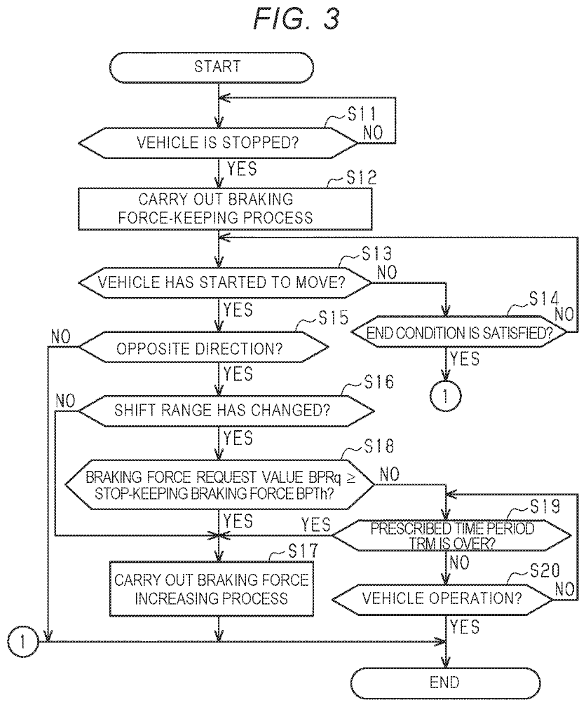

Subsequently, a process routine, which is executed by the braking control device 110 when the vehicle starts to decelerate as a result of an operation on the braking operation member 361, is described with reference to FIGS. 2 and 3. In the meantime, during the execution of the process routine, when it is detected that the braking operation member 361 is not operated, the execution of the process routine is over.

As shown in FIG. 3, in the process routine, in step S11, the determination unit 111 determines whether the vehicle is stopped, i.e., whether a transition is made from the stop-preceding moving state to the stopped state. Specifically, the determination unit 111 calculates a vehicle body speed VS of the vehicle, based on the wheel speed VW of the wheel 11 detected by the wheel speed sensor 202. When the calculated vehicle body speed VS is equal to or lower than a stop determination speed VSTh, the determination unit 111 determines that the vehicle is stopped. That is, it is determined that the transition is made from the stop-preceding moving state to the stopped state.

When it is not determined that the vehicle is stopped (step S11: NO), the determination of step S11 is repeated until it is determined that the vehicle is stopped. On the other hand, when it is determined that the vehicle is stopped (step S11: YES), the process proceeds to next step S12. In step S12, a braking force-keeping process for keeping the braking force for a vehicle with a magnitude at the time when it is determined that the vehicle is stopped is carried out by the braking control unit 112. When the operation amount on the braking operation member 361 is reduced in a situation where the braking force-keeping process is carried out, the braking force for a vehicle is more difficult to be reduced than when the operation amount on the braking operation member 361 is reduced in a situation where the braking force-keeping process is not carried out. On the other hand, when the operation amount on the braking operation member 361 is increased in the situation where the braking force-keeping process is carried out, the braking force for a vehicle is increased, like the case where the operation amount on the braking operation member 361 is increased in the situation where the braking force-keeping process is not carried out.

Subsequently, in next step S13, the determination unit 111 determines whether the vehicle has started to move, i.e., whether a transition is made from the stopped state to the stop-following moving state. Specifically, when it is detected that the wheel 11 is being rotated, based on the wheel speed VW detected by the wheel speed sensor 202, the determination unit 111 determines that the vehicle has started to move, i.e., determines that a transition is made from the stopped state to the stop-following moving state.

When it is not determined that the vehicle has started to move (step S13: NO), the process proceeds to next step S14. Then, in step S14, the braking control unit 112 determines whether an end condition of the execution of the process routine is satisfied. For example, the end condition includes a condition that the shift range has changed to the P range. When it is determined that the end condition is not satisfied (step S14: NO), the process proceeds to step S13. On the other hand, when it is determined that the end condition is satisfied (step S14: YES), the process routine is over.

On the other hand, when it is determined in step S13 that the vehicle has started to move (YES), the process proceeds to next step S15. Then, in step S15, the determination unit 111 determines whether the current moving direction of the vehicle, i.e., the moving direction of the vehicle in the stop-following moving state is an opposite direction to the moving direction of the vehicle in the stop-preceding moving state. When it is determined that the moving direction of the vehicle in the stop-following moving state is the same as the moving direction of the vehicle in the stop-preceding moving state (step S15: NO), the process routine is over.

On the other hand, when the moving direction of the vehicle in the stop-following moving state is the opposite direction to the moving direction of the vehicle in the stop-preceding moving state (step S15: YES), the process proceeds to next step S16. Then, in step S16, the determination unit 111 determines whether the shift range has changed. Specifically, when the moving direction of the vehicle in the stop-preceding moving state is the forward movement direction and the shift range is the D range upon the transition from the stop-preceding moving state to the stopped state, the determination unit 111 determines that the shift range has changed if the current shift range is the R range or the N range, and does not determine that the shift range has changed if the current shift range is the D range. Also, when the moving direction of the vehicle in the stop-preceding moving state is the backward movement direction and the shift range is the R range upon the transition from the stop-preceding moving state to the stopped state, the determination unit 111 determines that the shift range has changed if the current shift range is the D range or the N range, and does not determine that the shift range has changed if the current shift range is the R range.

When it is not determined that the shift range has changed (step S16: NO), the process proceeds to next step S17. When the moving direction of the vehicle in the stop-following moving state is the opposite direction to the moving direction of the vehicle in the stop-preceding moving state even though it is not determined that the shift range has changed, there is a possibility that although the driver wants to keep the stopped state of the vehicle, it is not possible to keep the stopped state of the vehicle because the braking force for a vehicle is small. Therefore, in step S17, the braking force increasing process is carried out by the braking control unit 112. Then, the process routine is over.

On the other hand, when it is determined in step S16 that the shift range has changed (YES), the process proceeds to next step S18. Then, in next step S18, the braking control unit 112 determines whether the braking force request value BPRq, which is a braking force requested by the driver, is equal to or greater than a stop-keeping braking force BPTh set as a braking force capable of keeping the stopped state. Specifically, the braking control unit 112 calculates the braking force request value BPRq so that it becomes greater as the MC pressure Pmc associated with the operation amount on the braking operation member 361 is higher. Also, the braking control unit 112 deduces the stop-keeping braking force BPTh on the basis of a gradient θ of the road surface on which the vehicle is located and the selected shift range by using a map shown in FIG. 2.

Here, the map shown in FIG. 2 is described. The solid line in FIG. 2 indicates a relation between the gradient θ of the road surface and the stop-keeping braking force BPTh when the selected shift range is the N range. Also, the broken line in FIG. 2 indicates a relation between the gradient θ of the road surface and the stop-keeping braking force BPTh when the selected shift range is the D range. Also, the dashed-dotted line in FIG. 2 indicates a relation between the gradient θ of the road surface and the stop-keeping braking force BPTh when the selected shift range is the R range.

As shown with the solid line in FIG. 2, in the case where the N range is selected, the stop-keeping braking force BPTh is smallest when the gradient θ is the same as a first gradient θ1. When the gradient θ is the same as the first gradient θ1, the road surface can be regarded as a flat road. The stop-keeping braking force BPTh becomes greater as a difference between the gradient θ and the first gradient θ increases.

As shown with the broken line in FIG. 2, in the case where the D range is selected, the stop-keeping braking force BPTh is smallest when the gradient θ is the same as a second gradient θ2. In the meantime, the second gradient θ2 is greater than the first gradient θ1. When the gradient θ is the same as the second gradient θ2, the road surface can be regarded as an uphill road. The stop-keeping braking force BPTh becomes greater as a difference between the gradient θ and the second gradient θ2 increases.

As shown with the dashed-dotted line in FIG. 2, in the case where the R range is selected, the stop-keeping braking force BPTh is smallest when the gradient θ is the same as a third gradient θ3. In the meantime, the third gradient θ3 is smaller than the first gradient θ1. When the gradient θ is the same as the third gradient θ3, the road surface can be regarded as a downhill road. The stop-keeping braking force BPTh becomes greater as a difference between the gradient θ and the third gradient θ3 increases.

Returning to FIG. 3, when it is determined in step S18 that the braking force request value BPRq is equal to or greater than the stop-keeping braking force BPTh (YES), the process proceeds to step S17 described above. That is, when the vehicle starts to move even though the braking force request value BPRq is equal to or greater than the stop-keeping braking force BPTh, since an actual braking force for the vehicle is smaller than the braking force request value BPRq, it can be determined that the stopped state of the vehicle cannot be kept and the vehicle has started to move. For this reason, in this case, the braking force increasing process is carried out by the braking control unit 112.

On the other hand, when it is determined that the braking force request value BPRq is smaller than the stop-keeping braking force BPTh (step S18: NO), the process proceeds to next step S19. In this case, it may be determined that there is a possibility that the driver reduces the operation amount on the braking operation member 361 so as to allow the transition from the stopped state to the stop-following moving state. Then, in step S19, the braking control unit 112 determines whether prescribed time has elapsed from the time when the movement of the vehicle was detected, i.e., from the transition from the stopped state to the stop-following moving state, i.e., whether a prescribed time period TRM is over. When the movement of the vehicle in the opposite direction to the moving direction of the vehicle in the stop-preceding moving state is based on the driver's request, a vehicle operation for traveling the vehicle may be performed during the prescribed time period TRM. Here, the “vehicle operation for traveling the vehicle” includes a braking operation of reducing the operation amount on the braking operation member 361, a steering operation of operating a steering wheel of the vehicle, and an accelerator operation of operating an accelerator pedal.

When it is determined in step S19 that the prescribed time period TRM is not over (NO), the process proceeds to next step S20. Then, in step S20, the braking operation member 361 determines whether the vehicle operation as described above is performed. When it is determined that the vehicle operation is not performed (step S20: NO), the process proceeds to step S19. On the other hand, when it is determined that the vehicle operation is performed (step S20: YES), the process routine is over without carrying out the braking force increasing process. That is, when the vehicle operation is performed during the prescribed time period TRM, the braking force for a vehicle is not increased.

On the other hand, when it is determined in step S19 that the prescribed time period TRM is over (YES), the process proceeds to step S17 described above. That is, when the vehicle operation is not performed during the prescribed time period TRM, it may be determined that the movement of the vehicle in the opposite direction to the moving direction of the vehicle in the stop-preceding moving state is not a state requested by the driver. Therefore, in this case, the braking control unit 112 carries out the braking force increasing process.

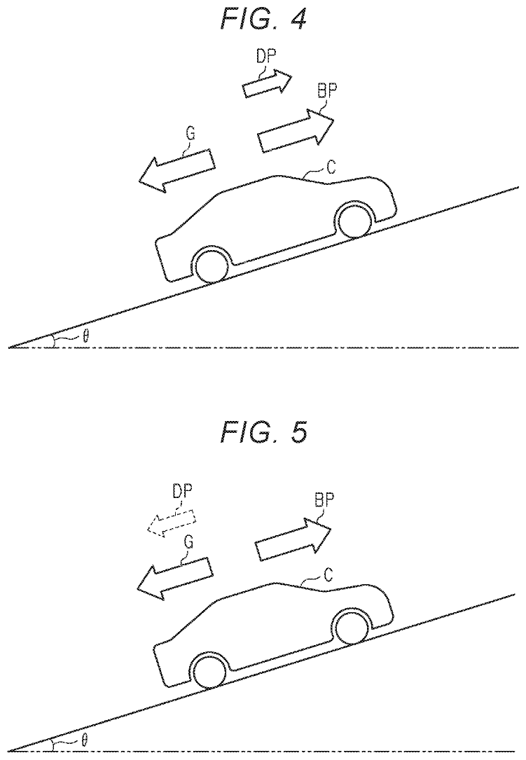

Subsequently, operations that are performed when the vehicle C travels on the uphill road are described together with effects, with reference to FIGS. 4 and 5. In the meantime, it is premised that even when the vehicle C is stopped, the operation of the engine 21 is not automatically stopped.

When the engine 21 is operated in the state where the shift range is the D range, the vehicle C moves uphill on the uphill road, i.e., in the forward movement direction. Then, when the braking force BP is applied to the vehicle C as a result of the driver's operation on the braking operation member 361, the vehicle C decelerates and stops. That is, the vehicle C transitions from the stop-preceding moving state to the stopped state.

As shown in FIG. 4, when the vehicle C is stopped on the uphill road, the gravity G applied to the vehicle C operates downhill, i.e., in the backward movement direction. Also, as a force of restraining the vehicle C from moving downhill, the braking force BP and the drive force DP are applied to the vehicle C. In the stopped state, a sum of the braking force BP and the drive force DP is balanced with the gravity G.

Like this, when the shift range is changed from the D range to the N range in the stopped state of the vehicle C, the drive force DP is “0”. At this time, when the braking force BP is smaller than the gravity G, the vehicle C starts to move downhill. That is, the vehicle C transitions from the stopped state to the stop-following moving state.

On the other hand, as shown with the arrow of the broken line in FIG. 5, when the shift range is changed from the D range to the R range in the stopped state of the vehicle C, the drive force DP is applied to the vehicle C, as a force of moving downhill the vehicle C. At this time, when the braking force BP is smaller than a sum of the gravity G and the drive force DP, the vehicle C starts to move downhill. That is, the vehicle C transitions from the stopped state to the stop-following moving state.

Until the prescribed time period TRM, which starts from the start time of the downhill movement of the vehicle C, is over, when at least one of the braking operation of reducing the operation amount on the braking operation member 361, the accelerator operation and the steering operation is performed, the braking force increasing process is not carried out. That is, when such a vehicle operation is performed during the prescribed time period TRM, since it can be determined that the downhill movement of the vehicle C is a state desired by the driver, the braking force BP for the vehicle C is not increased. As a result, the vehicle C continues to move downhill. Therefore, it is possible to move downhill the vehicle C, which is moving uphill on the slope road, by changing the shift range during the stop of the vehicle C.

On the other hand, until the prescribed time period TRM, which starts from the start time of the downhill movement of the vehicle C, is over, when the vehicle operation as described above is not performed, it cannot be determined that that the downhill movement of the vehicle C is a state desired by the driver. For this reason, in the first exemplary embodiment, the braking force increasing process is carried out to increase the braking force BP for the vehicle C. Therefore, it is possible to suppress the downhill movement of the vehicle C.

Also, when the vehicle C moves downhill, if the braking force request value BPRq is equal to or greater than the stop-keeping braking force BPTh, since the actual braking force BP for the vehicle C is smaller than the braking force request value BPRq, there is a possibility that the vehicle C is moving downhill contrary to driver's intention. For this reason, in this case, the braking force increasing process is carried out to increase the braking force BP for the vehicle C. Therefore, it is possible to suppress the downhill movement of the vehicle C.

On the other hand, when the vehicle C moves downhill, if the braking force request value BPRq is smaller than the stop-keeping braking force BPTh, it can be determined that that the downhill movement of the vehicle C is a state desired by the driver. For this reason, when the vehicle operation as described above is performed until the prescribed time period TRM is over, the braking force increasing process is not carried out. As a result, the braking force BP for the vehicle C is not increased, so that it is possible to move downhill the vehicle C.

Subsequently, operations that are performed when the vehicle C travels on the uphill road in the state where the shift range is the R range are described together with effects. In the meantime, it is premised that even when the vehicle C is stopped, the operation of the engine 21 is not automatically stopped.

When the engine 21 is operated in the state where the shift range is the R range, the vehicle C moves uphill on the uphill road, i.e., in the backward movement direction. Then, when the braking force BP is applied to the vehicle C as a result of the driver's operation on the braking operation member 361, the vehicle C decelerates and stops. That is, the vehicle C transitions from the stop-preceding moving state to the stopped state.

When the vehicle C is stopped on the uphill road, the gravity G applied to the vehicle C operates downhill. Also, as a force of restraining the vehicle C from moving downhill, the braking force BP and the drive force DP are applied to the vehicle C. In the stopped state, a sum of the braking force BP and the drive force DP is balanced with the gravity G.

Like this, when the shift range is changed from the R range to the N range in the stopped state of the vehicle C, the drive force DP is “0”. At this time, when the braking force BP is smaller than the gravity G, the vehicle C starts to move downhill, i.e., in the forward movement direction. That is, the vehicle C transitions from the stopped state to the stop-following moving state.

Also, when the shift range is changed from the R range to the D range in the stopped state of the vehicle C, the drive force DP is applied to the vehicle C, as a force of moving downhill the vehicle C. At this time, when the braking force BP is smaller than a sum of the gravity G and the drive force DP, the vehicle C starts to move downhill. That is, the vehicle C transitions from the stopped state to the stop-following moving state.

Then, when two conditions to be described below are satisfied, it can be determined that the downhill movement of the vehicle C is a state requested by the driver. (Condition 1) The braking force request value BPRq should be smaller than the stop-keeping braking force BPTh. (Condition 2) Until the prescribed time period TRM, which starts from the start time of the downhill movement of the vehicle C, is over, at least one of the braking operation of reducing the operation amount on the braking operation member 361, the accelerator operation and the steering operation should be performed.

When both the two conditions are satisfied, the braking force increasing process is not carried out. As a result, since the braking force BP for the vehicle C is not increased, the vehicle C continues to move downhill. Therefore, it is possible to move downhill the vehicle C, which is moving uphill on the slope road, by changing the shift range during the stop of the vehicle C.

On the other hand, when at least one of the two conditions is not satisfied even though the vehicle C moves downhill, the braking force increasing process is carried out to increase the braking force BP for the vehicle C. As a result, the downhill movement of the vehicle C is suppressed.

### Second Exemplary Embodiment

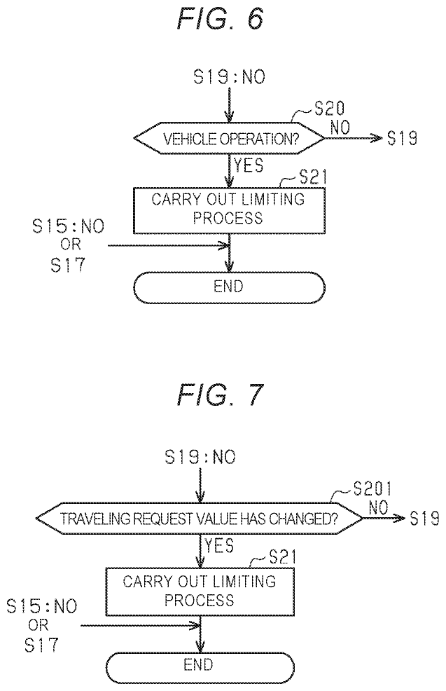

Subsequently, a second exemplary embodiment of the braking control device for a vehicle is described with reference to FIG. 6. In the second exemplary embodiment, a part of the process that is to be executed when the moving direction of the vehicle in the stop-following moving state is the opposite direction to the moving direction of the vehicle in the stop-preceding moving state is different from the first exemplary embodiment. Therefore, in the below, the differences from the first exemplary embodiment are described, and the members, which are the same as or equivalent to the first exemplary embodiment, are denoted with the same reference numerals, and the overlapping descriptions thereof are omitted.

In the second exemplary embodiment, when the moving direction of the vehicle in the stop-following moving state is the opposite direction to the moving direction of the vehicle in the stop-preceding moving state, the braking force for a vehicle is increased, unlike the first exemplary embodiment. However, at this time, the increase amount of the braking force is smaller than the increase amount of the braking force when the braking force increasing process of step S17 is carried out.

Subsequently, a process routine, which is executed by the braking control device 110 when the vehicle starts to decelerate as a result of an operation on the braking operation member 361, is described with reference to FIG. 6. Meanwhile, in FIG. 6, a process different from the process routine described with reference to FIG. 3, and previous and succeeding processes thereof are shown.

As shown in FIG. 6, when the moving direction of the vehicle in the stop-following moving state is the opposite direction to the moving direction of the vehicle in the stop-preceding moving state (step S15: YES), the shift range has changed (step S16: YES) and the braking force request value BPRq is smaller than the stop-keeping braking force BPTh (step S18: NO), the process proceeds to step S19. Then, when the vehicle operation as described above is performed during the prescribed time period TRM (step S20: YES), the process proceeds to next step S21. Then, in next step S21, a limiting process is carried out by the braking control unit 112. The limiting process is one of the braking force increasing process of increasing the braking force for a vehicle. However, the limiting process is a process of increasing the braking force for a vehicle by the actuation of the braking actuator 37 but making the increase amount of the braking force smaller than that in the braking force increasing process of step S17. For example, in the limiting process, a braking force with which the movement of the vehicle can be kept is applied to the vehicle. Then, the process routine is over.

In the second exemplary embodiment, when the shift range is changed in the stopped state and the transition is made from the stopped state to the stop-following moving state, if the above conditions 1 and 2 are all satisfied, the increase amount of the braking force BP for the vehicle C is smaller, as compared to the case where the braking force increasing process of step S17 is carried out. For this reason, the moving state of the vehicle C is difficult to be suppressed. Therefore, it is possible to suppress the vehicle C from being stopped even though the driver desires to continue the stop-following moving state.

### Third Exemplary Embodiment

Subsequently, a third exemplary embodiment of the braking control device for a vehicle is described with reference to FIG. 7. In the third exemplary embodiment, it is described that a transition is made in order of the stop-preceding moving state, the stopped state and the stop-following moving state in a situation where automatic driving of the vehicle is performed. In the meantime, in the below, the differences from the first and second exemplary embodiments are described, and the members, which are the same as or equivalent to the first and second exemplary embodiments, are denoted with the same reference numerals, and the overlapping descriptions thereof are omitted.

When the vehicle is stopped on the slope road due to the braking force applied during the automatic driving of the vehicle, the transition is made from the stop-preceding moving state to the stopped state. Then, when the shift range is changed in the stopped state and the vehicle starts to move in the opposite direction to the moving direction of the vehicle in the stop-preceding moving state, the transition is made from the stopped state to the stop-following moving state. In this case, when two conditions to be described below are all satisfied, the braking force increasing process of step S17 is not carried out. On the other hand, when at least one of the two conditions is not satisfied, the braking force increasing process of step S17 is carried out. (Condition 3) The braking force request value BPRq should be smaller than the stop-keeping braking force BPTh. (Condition 4) Until the prescribed time period TRM, which starts from the start time of the downhill movement of the vehicle C, is over, a traveling request value for a vehicle-mounted device for controlling a traveling aspect of the vehicle should be changed.

The braking force request value BPRq during the automatic driving is deduced by the automatic driving control device 140. Also, the vehicle-mounted device described herein is a vehicle-mounted device directly relating to the traveling of the vehicle, and includes the engine 21, the braking device 35, and a steering angle adjusting device configured to adjust a steering angle of the wheel. Also, the traveling request value is an output request value for the engine 21, a request value for the braking device 35, i.e., the braking force request value BPRq, and a request value for the steering angle adjusting device, i.e., a request value for a steering angle of the wheel 11.

Subsequently, a process routine, which is executed by the braking control device 110 when the vehicle starts to decelerate by the braking force applied as a result of an operation on the braking device 35, is described with reference to FIG. 7. Meanwhile, in FIG. 7, a process different from the process routine described with reference to FIG. 3, and previous and succeeding processes thereof are shown.

As shown in FIG. 7, when the moving direction of the vehicle in the stop-following moving state is the opposite direction to the moving direction of the vehicle in the stop-preceding moving state (step S15: YES), the shift range has changed (step S16: YES) and the braking force request value BPRq is smaller than the stop-keeping braking force BPTh (step S18: NO), the process proceeds to step S19. Then, when the prescribed time period TRM is not over yet (step S19: NO), the process proceeds to next step S201. Instep S201, the braking control unit 112 determines whether the traveling request value has changed. When the traveling request value has not changed (step S201: NO), the process proceeds to step S19. On the other hand, when the traveling request value has changed (step S201: YES), the process proceeds to next step S21. Then, in step S21, the braking control unit 112 carries out the limiting process. Thereafter, the process routine is over.

In the third exemplary embodiment, during the automatic driving of the vehicle, when the shift range is changed in the stopped state and the transition is made from the stopped state to the stop-following moving state, if the conditions 3 and 4 are all satisfied, the increase amount of the braking force BP for the vehicle C is smaller, as compared to the case where the braking force increasing process of step S17 is carried out. For this reason, the moving state of the vehicle is difficult to be suppressed. Therefore, it is possible to suppress the vehicle C from being stopped.

Meanwhile, the respective exemplary embodiments can be changed to other exemplary embodiments as described below.

Even though the braking force request value BPRq is equal to or greater than the stop-keeping braking force BPTh, the braking force increasing process may not be carried out when the moving direction of the vehicle in the stop-following moving state is the opposite direction to the moving direction of the vehicle in the stop-preceding moving state.

In the third exemplary embodiment, when the traveling request value has changed (step S201: YES), the braking force increasing process of step S17 and the limiting process may not be carried out, i.e., the braking force for a vehicle may not be increased.

When the moving direction of the vehicle in the stop-following moving state is the opposite direction to the moving direction of the vehicle in the stop-preceding moving state, the braking force increasing process may not be carried out, i.e., the braking force may not be increased, irrespective of whether the vehicle operation is performed within the prescribed time period TRM until prescribed time has elapsed since the change time of the shift range. Alternatively, the limiting process may be carried out instead of the braking force increasing process of step S17.

When the vehicle is provided with an electric parking device, the electric parking device other than the braking actuator 37 configured to adjust the WC pressure Pwc may be actuated in the braking force increasing process of step S17, thereby increasing the braking force for a vehicle. In this case, the electric parking device functions as the braking device.

1. A braking control device for a vehicle comprising:
a determination unit that determines, when a transition is made from a stop-preceding moving state where a vehicle travels in one direction of a forward movement direction and a backward movement direction to a stopped state where the vehicle stops, whether a shift range has changed from a range for one direction to a range for other direction or to a neutral range, the range for one direction being a shift range for enabling the vehicle to travel in the one direction, and the range for other direction being a shift range for enabling the vehicle to travel in the other direction of the forward movement direction and the backward movement direction; and
a braking control unit that, in a situation where it is determined that the shift range has changed from the range for one direction to the range for other direction or the neutral range upon the transition from the stop-preceding moving state to the stopped state, carries out a braking force increasing process of increasing a braking force for a vehicle by an actuation of a braking device for a vehicle when a transition is made from the stopped state to a stop-following moving state where the vehicle moves,
wherein even when the transition is made from the stopped state to the stop-following moving state in the situation that the determination unit has determined that the shift range has changed from the range for one direction to the range for other direction or the neutral range upon the transition from the stop-preceding moving state to the stopped state, the braking control unit does not carry out the braking force increasing process or carries out a limiting process of reducing an increase amount of the braking force in the braking force increasing process while increasing the braking force for the vehicle, on condition that a moving direction of the vehicle in the stop-following moving state is an opposite direction to a moving direction of the vehicle in the stop-preceding moving state.

2. The braking control device for a vehicle according to claim 1, wherein even when the transition is made from the stopped state to the stop-following moving state in the situation that the determination unit has determined that the shift range has changed from the range for one direction to the range for other direction or the neutral range upon the transition from the stop-preceding moving state to the stopped state, the braking control unit does not carry out the braking force increasing process or carries out the limiting process, on condition that the moving direction of the vehicle in the stop-following moving state should be the opposite direction to the moving direction of the vehicle in the stop-preceding moving state and a vehicle operation for traveling the vehicle should be performed within a time period until prescribed time elapses since change time of the shift range.

3. The braking control device for a vehicle according to claim 1, wherein even when the transition is made from the stopped state to the stop-following moving state in the situation that the determination unit has determined that the shift range has changed from the range for one direction to the range for other direction or the neutral range upon the transition from the stop-preceding moving state to the stopped state, the braking control unit does not carry out the braking force increasing process or carries out the limiting process, on condition that the moving direction of the vehicle in the stop-following moving state should be the opposite direction to the moving direction of the vehicle in the stop-preceding moving state and a request value for a vehicle-mounted device for controlling a traveling aspect of the vehicle should be changed within a time period until prescribed time elapses since change time of the shift range.

4. The braking control device for a vehicle according to claim 1, wherein even when the transition is made from the stopped state to the stop-following moving state in the situation that the determination unit has determined that the shift range has changed from the range for one direction to the range for other direction or the neutral range upon the transition from the stop-preceding moving state to the stopped state, the braking control unit does not carry out the braking force increasing process or carries out the limiting process, on condition that the moving direction of the vehicle in the stop-following moving state should be the opposite direction to the moving direction of the vehicle in the stop-preceding moving state and a request value for the braking force for a vehicle should be smaller than a stop-keeping braking force, the stop-keeping braking force being a force capable of keeping the stopped state in the stopped state.

5. The braking control device for a vehicle according to claim 2, wherein even when the transition is made from the stopped state to the stop-following moving state in the situation that the determination unit has determined that the shift range has changed from the range for one direction to the range for other direction or the neutral range upon the transition from the stop-preceding moving state to the stopped state, the braking control unit does not carry out the braking force increasing process or carries out the limiting process, on condition that the moving direction of the vehicle in the stop-following moving state should be the opposite direction to the moving direction of the vehicle in the stop-preceding moving state and a request value for the braking force for a vehicle should be smaller than a stop-keeping braking force, the stop-keeping braking force being a force capable of keeping the stopped state in the stopped state.

6. The braking control device for a vehicle according to claim 3, wherein even when the transition is made from the stopped state to the stop-following moving state in the situation that the determination unit has determined that the shift range has changed from the range for one direction to the range for other direction or the neutral range upon the transition from the stop-preceding moving state to the stopped state, the braking control unit does not carry out the braking force increasing process or carries out the limiting process, on condition that the moving direction of the vehicle in the stop-following moving state should be the opposite direction to the moving direction of the vehicle in the stop-preceding moving state and a request value for the braking force for a vehicle should be smaller than a stop-keeping braking force, the stop-keeping braking force being a force capable of keeping the stopped state in the stopped state.
